(19) United States
(12) Patent Application Publication
(10) Pub. No.: US 2016/0051850 A1
(43) Pub. Date: Feb. 25, 2016

(54) Fire Protection System

(71) Applicant: Jolene Menard, New Bedford, MA (US)

(72) Inventor: Jolene Menard, New Bedford, MA (US)

(21) Appl. No.: 14/464,739

(22) Filed: Aug. 21, 2014

(51) Int. Cl. A62C 35/68

(52) U.S. Cl. CPC A62C 35/68

(57) ABSTRACT

A wild fire protection system is provided. The system is positioned about a building or buildings to be protected, and has a number of fire suppression distributors such as water spraying devices. A plurality of fire sensors are in computerized communication with the distributors and activate them once a fire is sensed. The system is configured to hold back an oncoming wildfire far enough from the building to prevent its damage, and to prevent the spread of the wildfire near the building.

### BACKGROUND OF THE INVENTION

1. Field of the Invention

The present invention relates generally to fire protection systems. More particularly, the present invention relates to building, neighborhood or other area-wide wildfire protection systems.

2. Description of Related Art

Wildfires are a common and widespread danger. These fires are becoming more and more problematic as the human population grows, because houses and other structures are being built closer and closer to forests that often experience these wildfires. While wildfires are a danger everywhere, they are particularly problematic in the western part of the United States of America.

A particular danger of wildfires is the loss of buildings, especially homes to the fires. As the fire approaches, the residents evacuate, and are forced to potentially abandon their homes permanently if they are destroyed or damaged by the fire. The uncertainty of leaving for safety causes a tremendous amount of anxiety for those forced to evacuate, and often causes them to take unsafe risks to preserve their dwellings.

Therefore, what is needed is a system that can protect houses, dwellings, and other structures from an oncoming wildfire by holding back the fire from coming too close to the structure.

### SUMMARY OF THE INVENTION

The subject matter of this application may involve, in some cases, interrelated products, alternative solutions to a particular problem, and/or a plurality of different uses of a single system or article.

In one aspect, a building fire suppression system is provided. The system includes a plurality of water distributors positioned around the building at a distance away from the building. These water distributors are configured to, when activated, spray a quantity of water or other fire suppressing substance around the building to hold back an oncoming fire. A plurality of fire sensors are similarly positioned around the building at a distance away from the building. These sensors are configured to detect an approaching fire. A computerized controller is in communication with both the fire sensors and water distributors. The computerized controller is configured to receive an input from one of the plurality of fire sensors and configured to activate at least one of the plurality of water distributors based on the received input.

### BRIEF DESCRIPTION OF THE DRAWINGS

FIG. 1 provides a view of an embodiment installed elements of the present invention.

FIG. 2 provides a communications schematic of an embodiment of the sensor and various elements of the present invention.

FIG. 3 provides a view of an embodiment of a piping system of the present invention.

FIG. 4 provides a detail view of an embodiment of a distributor of the present invention.

FIG. 5 provides a detail view of an embodiment of a distributor of the present invention.

### DETAILED DESCRIPTION

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments.

Generally, the present invention concerns a wildfire protection system for one, or more often, a plurality of buildings. These buildings may be of any type, though are generally homes or similar residential dwellings. The invention comprises a system of spraying distributor devices, sensors, and controllers disposed around a building or buildings that are configured to hold back a wildfire around the building, preventing the fire from coming close enough to the building to damage it.

The present invention is configured to prevent the encroachment of a wildfire, keeping the fire away from the structures it protects. While the invention may not extinguish the entire fire, it may prevent it from burning or otherwise damaging the protected buildings. Thus, when areas are evacuated because of a fire, those evacuated can leave with the reassurance that their homes, dwellings, and other buildings will be standing when they return.

The distributors of the system may be any device capable of applying a fire-suppressing substance over a relatively wide area, ranging from radiuses of 5 to 100 feet. In one embodiment, the distributors may spray fluid such as water. The distributors may spray this water in any direction, including 360 degrees, 180 degrees towards an oncoming fire, or any other range of spray. This angled spraying may be achieved by a plurality of nozzles, or a single wide angle nozzle. Other embodiments may involve the spraying of other fire-suppressing substances such as other liquids, foams, gasses including CO2 or Nitrogen, and the like.

Distributor nozzles may be of any type that may adequately distribute water or other material over a large area. In one water distributing embodiment of the invention, each distributor may have a combination of spraying nozzles, as well as fog nozzles which create a fine water mist.

The height and orientation of the distributors may vary depending on the terrain, foliage, surrounding tree height, and the like.

In some embodiments, the distributors may have a staggered distance from the building or buildings that they are protecting. As such, some distributors may be further away from the buildings than others. This may provide an optimal and multi-layered defense system to hold back the approaching fire.

Distributor systems may further have additional sensors attached to them such as fire sensors, as well as sensors that can track and identify wind speed and direction, which may help the operators to control the water psi, gpm, and type of pattern that will work most efficiently to extinguish an approaching fire.

The sensors of the system may be any type of sensor that can sense and identify that a fire is nearby. The sensor may operate based on detection of heat, smoke, light, and the like, rapid increases of any or all of the detected elements, or other factors. The sensors may be in communication with the distributors, either directly through a networked connection, indirectly by both the sensors and the distributors being in communication with a computerized control system, or a combination of the two, among other communication schemes. Generally however, the sensors provide an alert when activated. This alert may automatically activate one, some, or all of the distributors, or may alert a computer or monitor that one, some, or all of the distributors should be activated.

The distributors and sensors of the system may be positioned about building(s) at intervals allowing the distributors to create a perimeter that keeps fire back a distance sufficient to prevent damage to them. In one embodiment, the sensors are positioned nearby or on the distributors. In another embodiment, the sensors are positioned such that the distributors are closer to the building(s) than the sensors, causing the sensors to be farther away from the building and closer to an oncoming fire.

In an embodiment wherein the distributors spray water, each distributor may be connected to a water main system. In another embodiment, each distributor may be connected to a water pumping system that operates independently of the water main system used for providing plumbing and running water, etc. In still another embodiment, the distributors of the system may be connected to both the water main system, along with a backup system that is separate and independent of the water main system.

In many embodiments, the present invention is configured to be accessible by and integrated with firefighters and traditional wildfire response. For example, firefighters may be able to connect hoses to the distributor systems to manually fight an oncoming fire. In another example, fire safety equipment, firefighting equipment, and the like may be stored nearby to the distributor or in the distributor area. Further still, fire safety shelters may be installed as part of the system to allow firefighters, workers, or other people to seek shelter in the event that the fire overtakes them. These shelters may be marked on maps, GPS, may have a guiding beacon, and/or may be otherwise accessible and easily locatable. In a particular embodiment, the computerized controller may provide location information of a nearest shelter to a user requesting such information. The shelters may have a fireproof door and structure, and may contain survival equipment, oxygen, rations, water, and the like.

The system may be computer monitored and controlled, by either a central controller or a decentralized mobile computerized system. The system may have the sensors and the distributors in communication with the computer(s). Therefore, the distributors may be manually and/or automatically controlled by the computerized controller adding flexibility and oversight to the system. For example, as a fire is approaching, one of the distributors activates after a signal from a sensor alerts the computerized control system. A human operator supervising the computerized controller (or the computer itself) may activate adjacent distributors as a precaution and added protection. However, it should be understood that in most embodiments, continuous human monitoring will not be necessary because of the computerized control and communication between the sensors and distributors.

Video cameras may be further utilized by the system. These cameras are similarly in communication with the computerized control system, and allow additional monitoring of the status of the system and surrounding area.

In varying embodiments, power for the system may come from a hard-wired power grid, solar panels or wind turbines directly connected to the system, batteries, or any other electrical source.

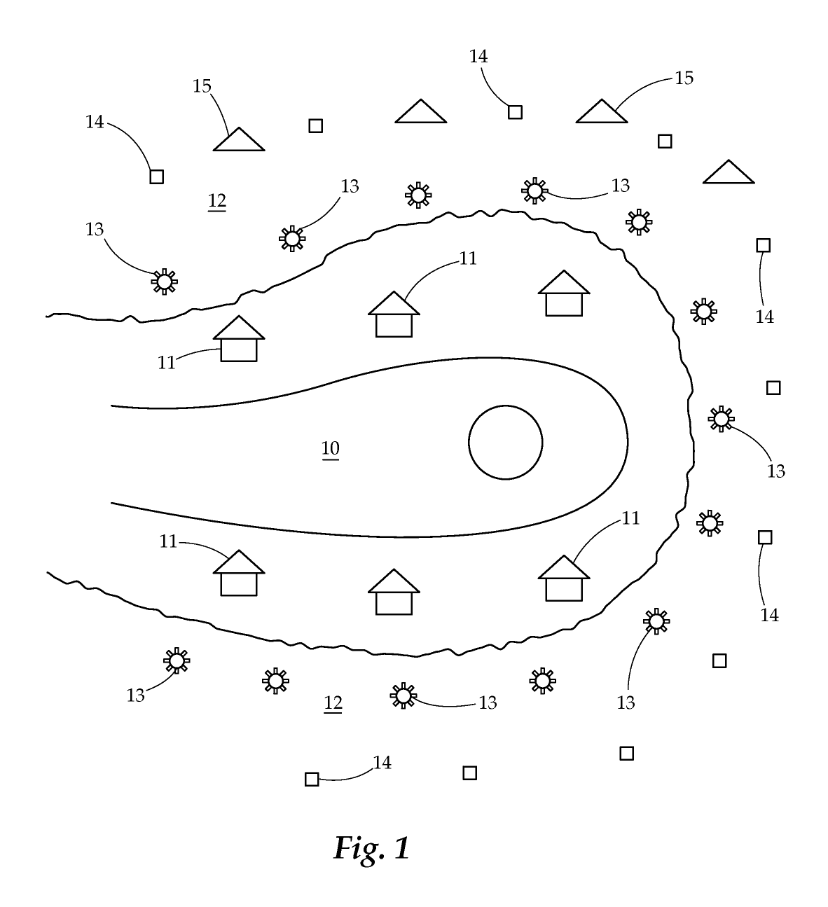

Turning now to FIG. 1 an overhead view of an embodiment of the system is provided. In this view, a neighborhood 10 is shown having the system surrounding it and protecting it from a wildfire damaging the houses 11. A plurality of distributors 13 are disposed about the houses 11 along the neighborhood's perimeter 12. While one row of distributors 13 are shown, it should be understood that, in varying embodiments, the distributors 13 may be staggered, and/or some distributors may extend further out into the wooded area. The perimeter 12 may be a wooded area, an end of the yards, a partially wooded area, and the like. In this embodiment, fire sensors 14 are positioned beyond the neighborhood perimeter 12. Sensors 14 are configured to detect if a fire is approaching. As noted above, sensors 14 may operate in any manner capable of identifying and detecting a fire. In addition to being separate from the distributors 13, as shown, the sensors 14 may also and/or alternatively be positioned on the distributors 13. These sensors 14 are in either direct or indirect communication with the distributors, and are configured to activate them or provide an instruction that they be activated upon sensing that a fire is present or approaching.

A plurality of fire safety shelters 15 are also positioned around the perimeter 12 of the neighborhood 11. These shelters 15, as discussed further below, are configured to allow firefighters to safely fight fires and take shelter if necessary. The shelters 15 may contain fire survival gear, fire extinguishers, and provisions to safely house a firefighter, firefighters, or others for a period of time for the fire to be put out or burn out.

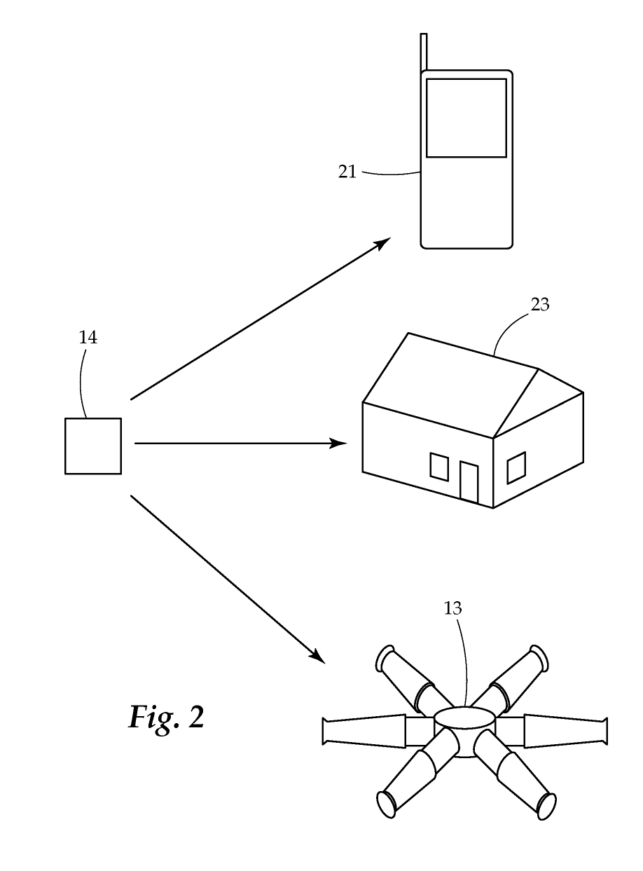

FIG. 2 shows a flow chart showing the communication path or paths of the sensor. In this view, sensor 14 may communicate with any of a telephone, cellular phone, or computer 21 or other contact method of a registered user. The sensor 14 may further communicate with a control station 23 containing a centralized server and control systems. Further still, the sensor 14 may communicate directly with one or a plurality of distributors 13. The distributor 13 is shown here as a 360 degree distributor having multiple nozzles.

In one embodiment of a cellular phone alert system for a user, the cellular phone of other networked mobile computing device may be configured to provide complete access and control to the system. For example, a display of the phone may be able to provide a touch screen interface to access a status indicator of each aspect and component of the system, along with sensor data. In a further embodiment, a user may be able to use the display to view a video feed of one of a plurality of cameras distributed throughout the area. The cellular phone may additionally have an ability to control any of the distributors, to activate one, many, or all of them using the control provided by the phone. Sensor data may be accessible by the phone as well. This sensor data may provide alerts and pre-alerts when a fire is approaching and/or when fire risk conditions become high. In this embodiment, different sensors, particularly alerting sensors may be accessed and may display the sensed information, such as temperature, wind speed and direction, and the like. Further still, the cell phone interface may provide an alert if someone has accessed the safe house during the emergency. This may allow the cell phone user to contact authorities to alert them that someone may be in danger. Moreover, the cellular phone interface may allow for control of the system during maintenance operations, such as for purging the system. The phone interface may also alert for minor maintenance issues, pinpointing the maintenance needs and allowing the user to easily keep up with the system maintenance and upkeep. The functionality discussed herein is provided by a combination of the programming and ability of the computerized cell phone, along with a networked connection between the cell phone and a control computer.

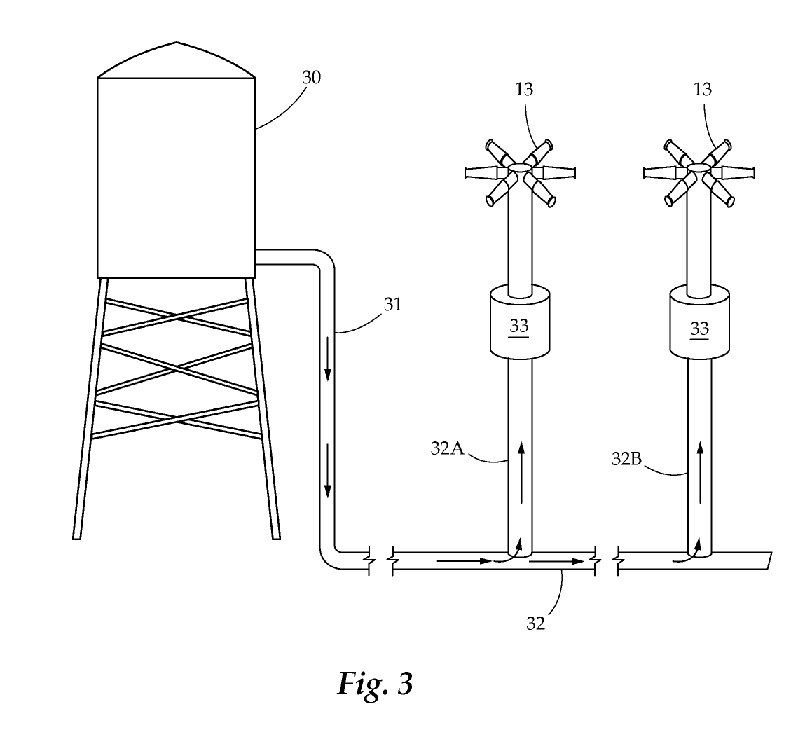

FIG. 3 provides a view of an embodiment of a piping system of the present invention. In this embodiment shown, the system comprises its own distributor piping system separate from a city water system or other existing piping system. A water tower 30 is shown that stores water for the system, and provides a gravity assisted water flow. This water may be pumped or otherwise flow through pipes 31 and 32 to distributor lines 32A and 32B for each of the plurality of distributors of the system. A distributor controller housing 33 controls distributor activation and comprises at least a valve, and optionally pumping and flow control capability. Once the distributor controller 33 is activated, it allows water to flow to the distributor 13 for spraying and fire suppression and control.

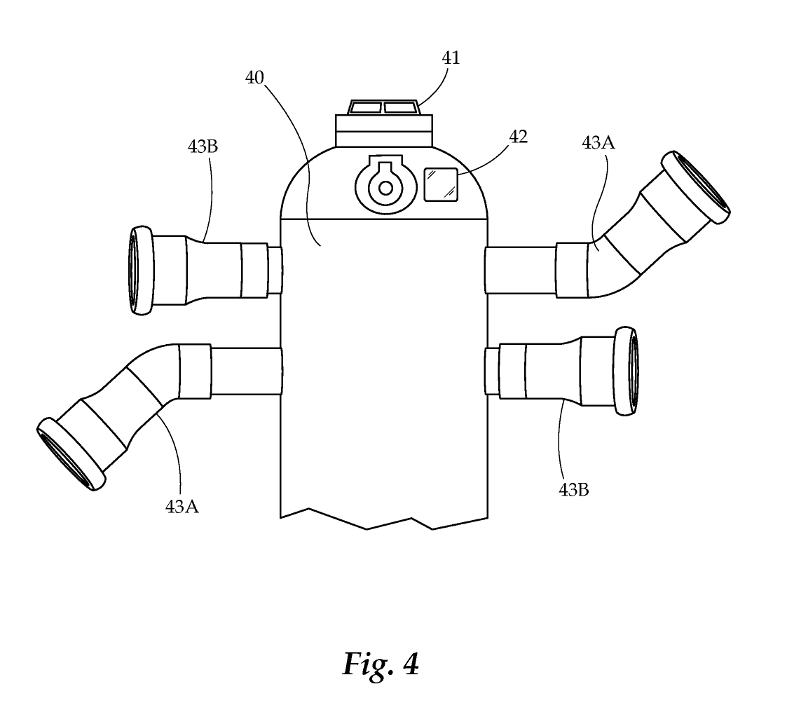

FIG. 4 provides a detail view of an embodiment of the distributor spraying portion. In this embodiment, the distributor comprises a body portion 40 providing support for the nozzles and distributor components. On top of the distributor body 40 is a sensor 41 that may be a heat or smoke detector. This sensor 41 may operate with the sensors 14 of the system. In a particular embodiment, sensor 41 may automatically activate the distributor to distribute the fire suppression substance. A touch screen controller and/or video monitor 42 is positioned on a vertical side of the body 40. A plurality of nozzles 43A, 43B extend out of the body 40 for spraying. The nozzles may be straight and fixed, such as 43B, or may be adjustable such as 43A. The adjustable nozzles 43A may allow them to be directed during set up to areas requiring the spraying. In some embodiments, standard 43A and fog 43B nozzles may be used. In one embodiment, the distributor may be controllable to determine activation of the different nozzles 43A, 43B.

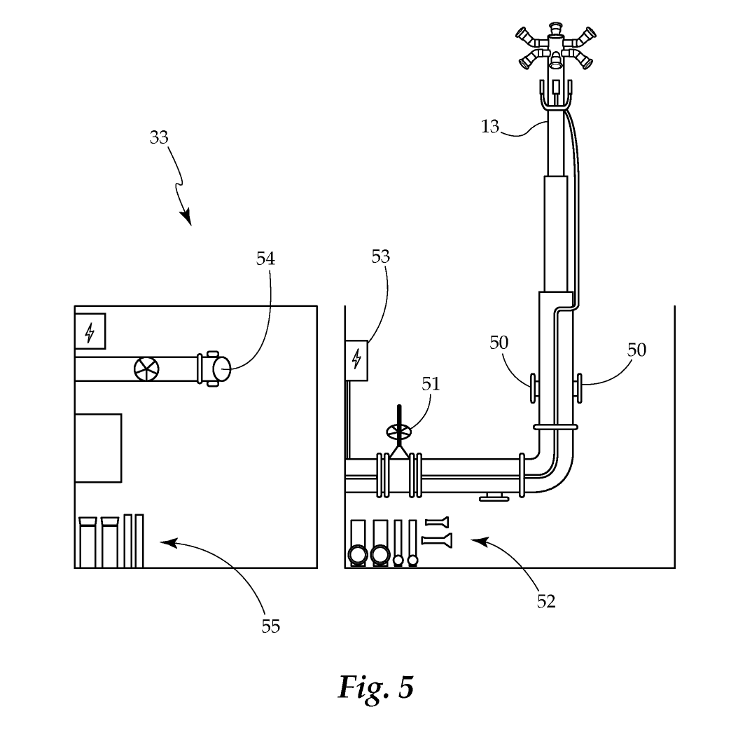

FIG. 5 provides a detail view of an embodiment of the distributor and its control system and surrounding area. In this embodiment, distributor 13 and controller housing 33 are shown in detail. The distributor 13 is connected to a telescoping piping that allows it to raise up during operation, and be compacted when not in use. A plurality of hose connections 50 are located on the distributor's 13 main piping. This may allow a firefighter to tap into the water line and use a fire hose to manually suppress the fire. Valve 51 controls fluid flow to the system. This valve 51 may be manual or in many embodiments is computer controllable either electronically or pneumatically via powered controller 53. Valve 51 may also have both automatic and manual control options. In an area about the distributor, which often may be a concrete poured foundation area or similar, are a quantity of tools and firefighting equipments 52 such as shovels, spanner wrenches, Storz connection parts, LDH manifolds, hoses and nozzles, other firefighting equipment 52, and the like. This equipment may further aid and protect firefighters and other workers nearby the distributor during a fire. In a particular embodiment, the distributor has an approximately 8 foot by 8 foot by 6 foot deep cement lined base area containing the above noted equipment, piping, and the like. In some embodiments, a drain may be positioned at the base of the distributor piping.

In this embodiment, a contained room is surrounding at least part of the distributor. This room houses piping 54 and other systems. In a particular embodiment, the room may be fire-proof or fire-resistant having fire-proof doors and walls, and may act as an emergency shelter for firefighters or workers nearby during a fire. Within the room is a quantity of equipment 55 including firefighting equipment that may include fire extinguishers, fire suits, hoses and the like, and other survival gear such as fresh water, rations, first aid kit, and the like.

While several variations of the present invention have been illustrated by way of example in preferred or particular embodiments, it is apparent that further embodiments could be developed within the spirit and scope of the present invention, or the inventive concept thereof. However, it is to be expressly understood that such modifications and adaptations are within the spirit and scope of the present invention, and are inclusive, but not limited to the following appended claims as set forth.

What is claimed is:

1. A building fire suppression system comprising:
a plurality of water distributors positioned around the building at a distance away from the building;
a plurality of fire sensors, the fire sensors in communication with a computerized controller; and
wherein the computerized controller is configured to receive an input from one of the plurality of fire sensors and configured to activate at least one of the plurality of water distributors based on the received input, and wherein the activation of the at least one of the plurality of water distributors comprises flowing water through a plurality of nozzles extending from the at least one of the plurality of water distributors.

2. The building fire suppression system of claim 1 wherein the plurality of nozzles comprises a spray nozzle and a fog nozzle.

3. The building fire suppression system of claim 1 further comprising an enclosed fire shelter, the fire shelter surrounding a piping of one of the plurality of water distributors, and sized and configured to allow a person to take shelter within it.

4. The building fire suppression system of claim 3 wherein the fire shelter comprises a fireproof door and a quantity of supplies.

5. The building fire suppression system of claim 1 wherein one of the plurality of water distributors comprises a hose connector on an inlet pipe.

6. The building fire suppression system of claim 5 further comprising a fire hose connected to the hose connector.

7. The building fire suppression system of claim 1 wherein a first of the plurality of water distributors is positioned at a first distance away from the building, and wherein a second of the plurality of water distributors is positioned at a second distance away from the building, the second distance being greater than the first distance.

8. The building fire suppression system of claim 7 wherein at least one of the plurality of sensors is positioned at a third distance away from the building, the third distance being greater than the first or second distance.

9. The building fire suppression system of claim 1 wherein at least one of the plurality of water distributors comprises a solar panel, the solar panel configured to generate electricity from sunlight.

10. The building fire suppression system of claim 1 further comprising a video camera in communication with the computerized controller.

11. The building fire suppression system of claim 1 further comprising a water piping system connected to each of the plurality of water distributors, the water piping system comprising a water source, a pump, and piping connecting the water source, pump, and each of the plurality of water distributors, the water piping system configured to provide pressurized water to the water distributors.

12. The building fire suppression system of claim 1 wherein the computerized controller is configured to provide an alert message to a cellular phone upon receiving an input from at least one of the plurality of sensors.

13. The building fire suppression system of claim 1 wherein the computerized controller may activate one of the plurality of water distributors based on a user input.

14. The building fire suppression system of claim 1 wherein the plurality of nozzles of each of the plurality of water distributors are configured to provide 360 degree water spray by each distributor.

15. The building fire suppression system of claim 1 wherein the plurality of nozzles of each of the plurality of water distributors are configured to provide 180 degree water spray in a direction of oncoming fire by each distributor.

16. A computer controlled method of suppressing a wildfire around a building using the system of claim 1 comprising the steps of:
detecting a fire by one of the plurality of fire sensors;
communicating a signal to the computerized controller by the sensor indicating a presence of the fire;
activating at least one of the plurality of water distributors by the computerized controller, wherein the activating step comprises spraying, by the nozzles of the water distributors, a large quantity of water about the area around the building, thereby suppressing the spread of the wildfire.

17. The method of claim 16 further comprising the step of providing a notification to a cellular phone by the computerized controller after receiving the signal from the sensor.

18. A neighborhood fire suppression system comprising:
a plurality of water distributors positioned around an outer perimeter of a plurality of homes of the neighborhood, in a direction away from the neighborhood and towards a wooded area, the plurality of water distributors positioned at a distance away from each of the plurality of homes;
a plurality of fire sensors, the fire sensors in communication with a computerized controller; and
wherein the computerized controller is configured to receive an input from one of the plurality of fire sensors and configured to activate at least one of the plurality of water distributors based on the received input, and wherein the activation of the at least one of the plurality of water distributors comprises flowing water through a plurality of nozzles extending from the at least one of the plurality of water distributors, the spraying wetting an area about the distributor.

19. The building fire suppression system of claim 1 further comprising an enclosed fire shelter, the fire shelter surrounding a piping of one of the plurality of water distributors, and sized and configured to allow a person to take shelter within it.

20. The building fire suppression system of claim 1 wherein a first of the plurality of water distributors is positioned at a first distance away from the neighborhood, and wherein a second of the plurality of water distributors is positioned at a second distance away from the neighborhood, the second distance being greater than the first distance; and
wherein at least one of the plurality of sensors is positioned at a third distance away from the neighborhood, the third distance being greater than the first or second distance.
